(19) United States
(12) Patent Application Publication
(10) Pub. No.: US 2026/0285057 A1
(43) Pub. Date: Sep. 24, 2026

(54) IMAGE FORMING APPARATUS AND METHOD OF FORMING IMAGE

(71) Applicant: Shigetoshi HOSAKA, Kanagawa (JP)

(72) Inventor: Shigetoshi HOSAKA, Kanagawa (JP)

(21) Appl. No.: 19/564,300

(22) Filed: Mar. 12, 2026

(30) Foreign Application Priority Data
Mar. 19, 2025 (JP) 2025-044237

(51) Int. Cl. B41J 2/21; B41J 3/407; B41J 11/00

(52) U.S. Cl. CPC B41J 2/2117; B41J 2/2132; B41J 3/4078; B41J 11/0015

(57) ABSTRACT

An image forming apparatus includes an applicator, a discharger, and processing circuitry. The applicator applies a pretreatment liquid to a fabric. The discharger discharges an ink onto the fabric. The processing circuitry controls operations of the applicator and the discharger. The processing circuitry causes the applicator to apply the pretreatment liquid and causes the discharger to discharge a white ink to form at least two base layers including the pretreatment liquid and the white ink.

### CROSS-REFERENCE TO RELATED APPLICATION

This patent application is based on and claims priority pursuant to 35 U.S.C. § 119(a) to Japanese Patent Application No. 2025-044237, filed on Mar. 19, 2025, in the Japan Patent Office, the entire disclosure of which is hereby incorporated by reference herein.

### BACKGROUND

### Technical Field

The present disclosure relate to an image forming apparatus that forms an image on a fabric and a method of forming an image on a fabric.

Related Art

An image forming apparatus called a garment printer that forms an image on a fabric has been developed. Such a garment printer forms an image by discharging ink onto a fabric. However, in the case of a fabric having a dark color such as black, the color of the ink may be difficult to see, and therefore, a base layer may be formed on the fabric. On the other hand, when the base layer is not appropriately formed, the quality of the image formed on the fabric may be deteriorated.

### SUMMARY

The present disclosure described herein provides an image forming apparatus that includes an applicator, a discharger, and processing circuitry. The applicator applies a pretreatment liquid to a fabric. The discharger discharges an ink onto the fabric. The processing circuitry controls operations of the applicator and the discharger. The processing circuitry causes the applicator to apply the pretreatment liquid and causes the discharger to discharge a white ink to form at least two base layers including the pretreatment liquid and the white ink.

The present disclosure described herein also provides a method of forming an image on a fabric. The method includes: applying a pretreatment liquid to the fabric; discharging a white ink to the fabric, after the applying of the pretreatment liquid, to form a white ink layer; and discharging a non-white ink, after repeating the applying of the pretreatment liquid and the forming of the white ink two or more times, to form the image on the fabric.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of hardware of an entire system.

FIG. 2 is a diagram illustrating an inkjet image forming apparatus;

FIGS. 3A and 3B are diagrams illustrating example configurations of a pretreatment liquid application mechanism;

FIG. 4 is a block diagram illustrating a hardware configuration of an image forming apparatus;

FIG. 5 is a block diagram of software included in an image forming apparatus;

FIG. 6 is a flowchart of an operation of an image forming apparatus;

FIGS. 7A, 7B, 7C, 7D, 7E, and 7F are sectional views of processes of forming an image;

FIGS. 8A and 8B are diagrams illustrating an example configuration of a base layer;

FIGS. 9A and 9B are diagrams illustrating an example configuration of a base layer;

FIGS. 10A and 10B are diagrams illustrating an example configuration of a base layer;

FIGS. 11A and 11B are diagrams illustrating example configurations of a base layer;

FIGS. 12A and 12B are diagrams illustrating an example configuration of a base layer.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Although the present disclosure is described below with reference to some embodiments, embodiments of the present disclosure are not limited to the embodiments described below. In the drawings referred to below, identical or similar signs are used for the common elements, and the description thereof may be omitted as appropriate.

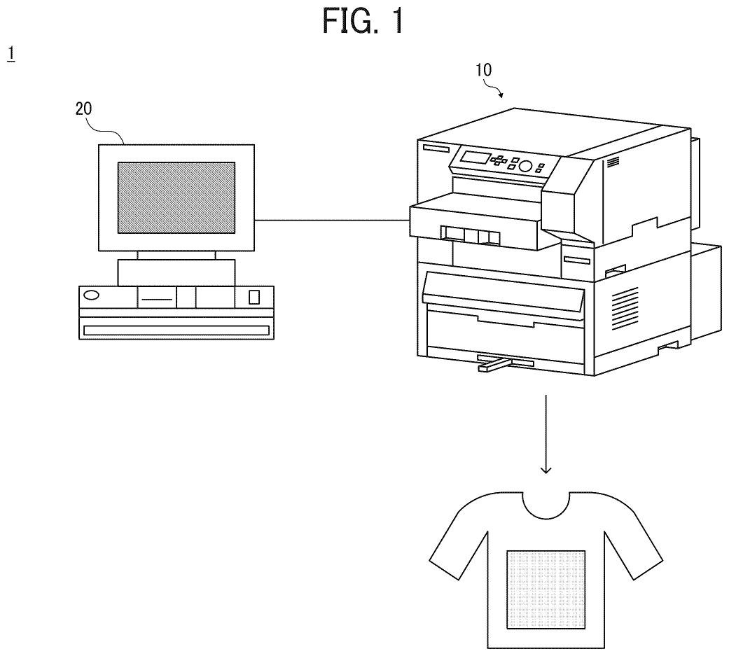

FIG. 1 is a block diagram illustrating a schematic configuration of hardware of an entire system. FIG. 1 illustrates a garment printer system 1 including an image forming apparatus 10 and a terminal 20 as an example. FIG. 1 illustrates an environment in which an image forming apparatus 10 and a terminal 20 are connected via a network such as the Internet or a local area network (LAN). The numbers of image forming apparatuses 10 and terminals 20 are not limited to those illustrated in FIG. 1, and the numbers of image forming apparatuses 10 and terminals 20 included in the garment printer system 1 are not limited to any particular numbers. The image forming apparatus 10 and the terminal 20 may be connected to the network in a wired or wireless manner.

The image forming apparatus 10 is an apparatus that forms an image on a fabric as a recording medium, and may be referred to as a garment printer. The image forming apparatus 10 can be configured as an inkjet image forming apparatus that forms an image by discharging ink onto a fabric. The configuration of the image forming apparatus 10 is an example, and does not particularly limit the embodiments. Accordingly, the image forming apparatus 10 may not necessarily be connected to the network, and may be configured to store data to be printed in, for example, a universal serial bus (USB) memory and to expand the print data from the USB memory and print the print data in the image forming apparatus 10.

The terminal 20 is a device such as a personal computer, and transmits a print job to the image forming apparatus 10 through an operation by a user. The terminal 20 can perform various print settings of jobs executed by the image forming apparatus 10.

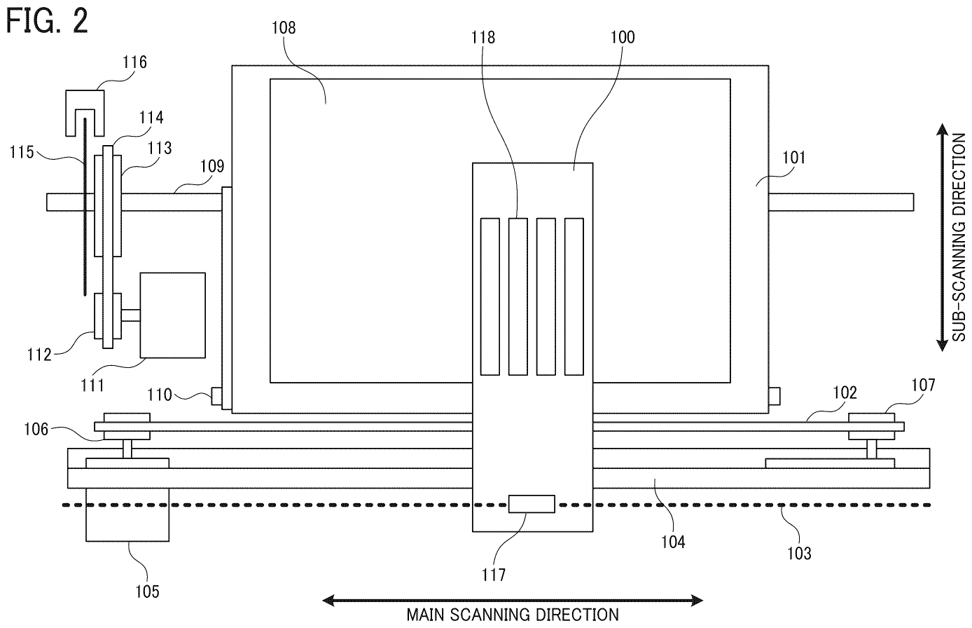

A description is given below of a configuration of the image forming apparatus 10. FIG. 2 is a diagram illustrating an overall configuration of an inkjet image forming apparatus 10.

The image forming apparatus 10 holds a carriage 100 by a slide rail 104 integrated with a sheet metal, and moves the carriage 100 for scanning in the main scanning direction by a main scanning motor 105 via a timing belt 102 stretched between a driving pulley 106 and a driven pulley 107.

The carriage 100 is mounted with a recording head 118 including liquid discharge heads for discharging ink droplets of colors (e.g., cyan, magenta, yellow, black, and white). The liquid discharge heads have nozzle surfaces including nozzle rows. Each of the nozzle rows includes a plurality of ink discharge ports (nozzles) arranged in a direction (sub-scanning direction) perpendicular to the main scanning direction, and the ink discharge ports are directed downward. Although independent droplet discharge heads are used in FIG. 2, a configuration may be adopted in which one or a plurality of heads having a plurality of nozzle rows for discharging droplets of recording liquids of the respective colors are used. The number of colors and the order of arrangement of the heads are not limited to the number and the arrangement order as described above.

As the inkjet heads of the recording head 118, piezoelectric actuators such as piezoelectric elements, thermal actuators using phase change due to film boiling of liquid by using electrothermal conversion elements such as heating resistors, shape memory alloy actuators using metal phase change due to temperature change, or electrostatic actuators using electrostatic force can be used as pressure generators that generate the pressure for discharging liquid droplets.

The carriage 100 is provided with an encoder scale 103 having slits formed therein along the main scanning direction. The carriage 100 is provided with an encoder sensor 117 for detecting the slits of the encoder scale 103. The encoder scale 103 and the encoder sensor 117 constitute at least part of a linear encoder for detecting the position of the carriage 100 in the main scanning direction. On the other hand, in order to convey the recording medium 108, a conveyance platen 101 is provided as a conveyor for conveying the recording medium 108 at a position facing the recording head 118.

The conveyance platen 101 is driven by a sub-scanning motor 111 that rotationally drives a conveyance roller 109 via a timing belt 114 stretched between a conveyance drive pulley 112 and a conveyance roller pulley 113. An encoder wheel 115 having a slit formed therein is mounted on the conveyance platen 101 coaxially with the conveyance roller 109, and an encoder sensor 116 for detecting the slit of the encoder wheel 115 is disposed on a side plate, thereby constituting at least part of a wheel encoder for detecting the position of the conveyance platen 101 in the sub-scanning direction. The conveyance platen 101 is of a flatbed type, and is stretched between the conveyance roller 109 and a tension roller 110 to be conveyed horizontally in the sub-scanning direction.

The image forming apparatus 10 can form a base layer in order to appropriately form an image on a fabric. For example, in a case where the color of the fabric is a dark color, even if the ink is directly discharged onto the fabric, the color of the ink may become inconspicuous depending on the color of the fabric, and an image may not be appropriately formed. For this reason, the image forming apparatus 10 may form an image after forming a base layer including a layer of white ink on the surface of the fabric.

On the other hand, when the base layer is formed, the white ink may pass through gaps between fibers of the fabric and may not be fixed to the surface of the fabric, and thus the base layer may not be appropriately formed. In particular, in a fabric made of chemical fibers such as polyester materials, there is almost no unevenness on the surface of the fibers, and thus it may be preferable to appropriately form the base layer. For this reason, the image forming apparatus 10 may include a mechanism that applies pretreatment liquid for keeping the white ink of the base layer on the fabric. The pretreatment liquid is also referred to as an undercoat, a base coat, or a pretreatment agent, and is a liquid agent that forms a layer for facilitating the ink to be applied to the surface of the fabric. By applying the pretreatment liquid to the base layer, an ink receiving layer is formed, the ink can be easily fixed to the fabric, and the ink can be prevented from bleeding.

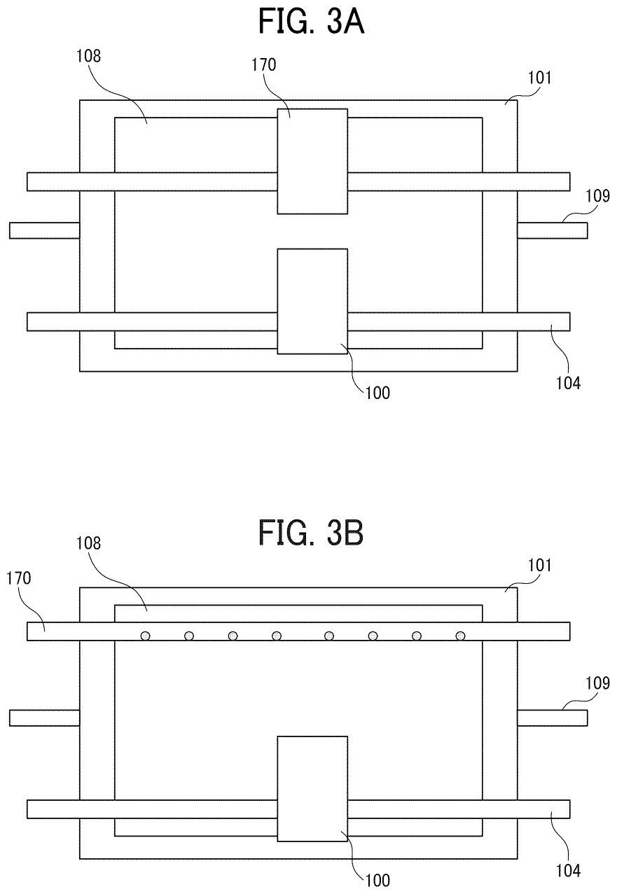

A description is given below of a mechanism that applies pretreatment liquid, with reference to FIG. 3. FIGS. 3A and 3B are diagrams illustrating example configurations of a pretreatment liquid application mechanism.

The pretreatment liquid application mechanism 170 can be configured to discharge pretreatment liquid from a discharge head mounted on a carriage and apply the pretreatment liquid to a fabric. For example, as illustrated in FIG. 3A, a carriage for the pretreatment liquid application mechanism 170 having the same configuration as the carriage 100 is disposed, and the pretreatment liquid is discharged in accordance with the movement of the carriage, so that the pretreatment liquid can be applied to the fabric. The pretreatment liquid application mechanism 170 may be disposed on the rear side with respect to the carriage 100 in the conveyance direction of the conveyance platen 101 (see the arrangement in FIG. 3A), or may be disposed on the front side with respect to the carriage 100 in the conveyance direction of the conveyance platen 101. By disposing the pretreatment liquid application mechanism 170 on the rear side of the carriage 100, ink can be discharged from the carriage 100 onto the fabric after the pretreatment liquid has been applied. Thus, the time for image formation can be shortened. Alternatively, by disposing the pretreatment liquid application mechanism 170 on the front side of the carriage 100, the maintainability of the pretreatment liquid application mechanism 170 can be enhanced.

The pretreatment liquid application mechanism 170 may be configured to apply pretreatment liquid by a spray method. For example, as illustrated in FIG. 3B, a pretreatment liquid application mechanism 170 includes a spray extending in a direction orthogonal to the moving direction of the conveyance platen 101. Pretreatment liquid is sprayed in accordance with the movement of a fabric, so that the pretreatment liquid can be applied. By applying the pretreatment liquid by the spray method, the time for applying the pretreatment liquid can be shortened.

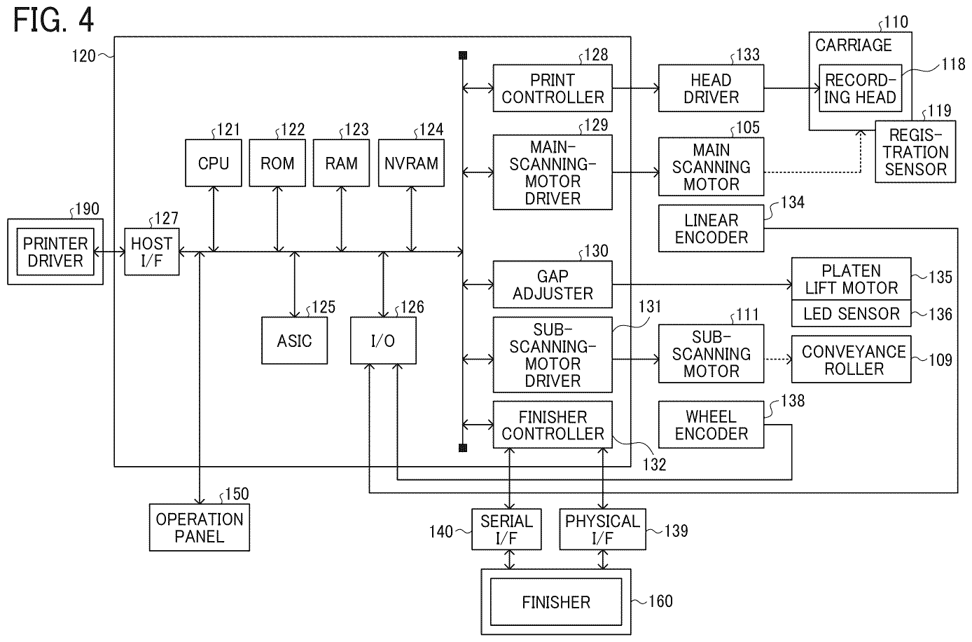

A description is given below of a hardware configuration of the image forming apparatus 10. FIG. 4 is a block diagram illustrating a hardware configuration of the image forming apparatus 10.

The controller 120 of the image forming apparatus 10 includes a central processing unit (CPU) 121 that is an information processing device that controls the entire apparatus and also controls the conveyance operation of a fabric and the movement operation of the recording head 118, a read-only memory (ROM) 122 that stores programs executed by the CPU 121 and other fixed data, a random-access memory (RAM) 123 that temporarily stores image data or other types of data, a rewritable non-volatile random-access memory (NVRAM) 124 for holding data even while the power source of the image forming apparatus 10 is shut down, and an application-specific integrated circuit (ASIC) 125 for performing various kinds of signal processing on image data, image processing for performing, e.g., sorting, and processing of input-and-output signals for controlling the entire apparatus.

The controller 120 includes a host interface (I/F) 127 for transmitting and receiving signals to and from the host side, a head controller 128 for generating a drive waveform for driving the recording head 118 and outputting image data for selectively driving pressure generators of the recording head 118 and various types of data accompanying the image data to a head driver, a main scanning motor driver 129 for driving the main scanning motor, a sub-scanning motor drivee 131 for driving the sub-scanning motor, and an input-and-output (I/O) 126 for inputting detection pulses from the linear encoder 134 and the wheel encoder 138 and detection signals from other various sensors. The controller 120 is connected to an operation panel 150 for inputting and displaying desired information to the image forming apparatus 10.

A registration sensor 119 mounted on the carriage 100 performs sensing of a recording medium.

The controller 120 receives, e.g., print job data generated by a printer driver 190 of a host device such as a terminal 20 such as a personal computer, an image reading device such as an image scanner, and an image capturing device such as a digital camera, via a cable or a network via the host I/F 127.

The CPU 121 of the controller 120 reads and analyzes print data in a reception buffer included in the host I/F 127, performs image processing, data sorting processing, and other processing in the ASIC 125, transfers the print data to the head controller 128, and outputs the image data and the drive waveform to the head driver from the head controller 128 at a suitable timing. Dot pattern data for image output may be generated based on font data stored in, for example, the ROM 122. The printer driver 190 may develop image data into bitmap data and transfer to the image forming apparatus 10 to generate the dot pattern data. In FIG. 4, for example, it is assumed that the printer driver 190 generates the dot pattern data for image output.

The head controller 128 includes a drive waveform generator including a digital-to-analog (D/A) converter and an amplifier. The D/A converter converts pattern data of a drive waveform stored in the ROM 122 and read out by the CPU 121 from digital to analog. The head controller 128 outputs a drive waveform including one or multiple drive pulses to the head driver 133.

The head driver 133 drives the recording head 118 by selectively applying, to the pressure generators of the recording head 118, drive pulses of a drive waveform given from a drive waveform generator of the head controller 128 based on image data (dot pattern data) corresponding to one line of the recording head 118 input in series. The head driver 133 includes, for example, a shift register that inputs a clock signal and serial data that is image data, a latch circuit that latches a register value of the shift register with a latch signal, a level conversion circuit (level shifter) that changes the level of an output value of the latch circuit, and an analog switch array (switcher) that is controlled to be turned on and off by the level shifter. The head driver 133 selectively applies drive pulses included in a drive waveform to the pressure generators of the recording head 118 by controlling on and off of the analog switch array.

A gap adjuster 130 drives the conveyance platen 101 up and down by a platen lift motor 135, and detects the conveyance platen 101 by a light-emitting diode (LED) sensor 136 to adjust the height.

A finisher controller 132 controls a finisher 160 and transmits and receives data. The power of the finisher 160 is turned on by a physical I/F 139, and the finisher 160 transmits and receives data by a serial I/F 140 such as a Recommended Standard (RS)-232C. The image forming apparatus 10 does not necessarily include the finisher 160, and may have, for example, a configuration in which ink is dried using a heat presser after printing, or a configuration in which ink is dried by heating a fabric on which an image is formed with a heater while conveying the fabric in a belt conveyor manner.

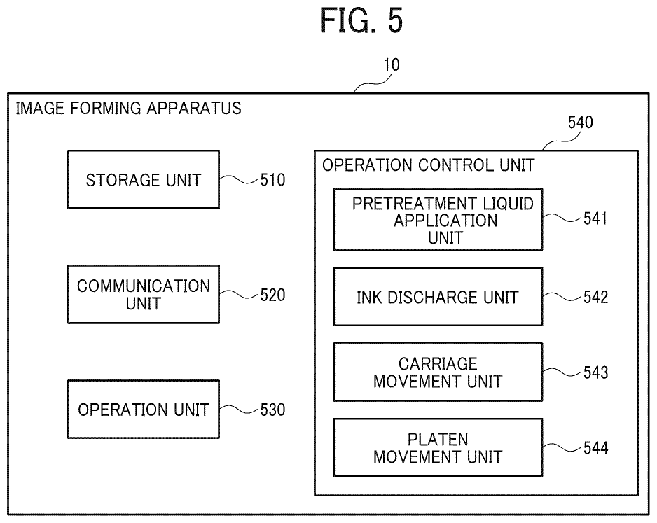

A hardware configuration of the image forming apparatus 10 has been described above. Functional units implemented with hardware of the image forming apparatus 10 are described below with reference to FIG. 5. FIG. 5 is a block diagram of the image forming apparatus 10.

As illustrated in FIG. 5, the image forming apparatus 10 includes functional units such as a storage unit 510, a communication unit 520, an operation unit 530, and an operation control unit 540. The functional units are described below.

The storage unit 510 controls operations of various storage devices (e.g., the ROM 122, the RAM 123, and the NVRAM 124) included in the image forming apparatus 10, and writes and reads out various programs and data. The storage unit 510 is an example of a storage unit. The storage unit 510 can temporarily store, for example, data of an image to be printed.

The communication unit 520 performs communications between the image forming apparatus 10 and another information processing apparatus. The communication unit 520 is an example of a communication unit. The communication unit 520 can receive a print job from the terminal 20 via, for example, a network.

The operation unit 530 performs various operations of the image forming apparatus 10. The operation unit 530 is an example of an operation unit. The operation unit 530 can receive, for example, an operation of a button via the operation panel 150, and thereby the image forming apparatus 10 can operate.

The operation control unit 540 controls an operation related to image formation of the image forming apparatus 10. The operation control unit 540 is an example of a control unit. The operation control unit 540 can control various operations based on a print job. As illustrated in FIG. 5, the operation control unit 540 includes a pretreatment liquid application unit 541, an ink discharge unit 542, a carriage movement unit 543, and a platen movement unit 544.

The pretreatment liquid application unit 541 is an example of an application unit and serves as an applicator together with the pretreatment liquid application mechanism 170. The pretreatment liquid application unit 541 can apply pretreatment liquid to a fabric in order to form a base layer.

The ink discharge unit 542 is an example of a discharge unit and serves as a discharger together with the recording head 118. The ink discharge unit 542 can discharge white ink in order to form the base layer. The ink discharge unit 542 can discharge non-white ink (e.g., cyan, magenta, yellow, or black) in order to form an image on the base layer.

The carriage movement unit 543 is an example of a movement unit and serves as a mover together with motors. The carriage movement unit 543 can move the carriage 100 to an appropriate position in the main scanning direction when forming the base layer or the image.

The platen movement unit 544 is an example of a movement unit and serves as a mover together with motors. The carriage movement unit 543 can move the conveyance platen 101 to an appropriate position in the sub-scanning direction when forming the base layer or the image.

The operation control unit 540 controls the operations of various constituent devices to apply pretreatment liquid and discharge ink at an appropriate position, thereby forming the base layer and the image.

The software blocks described above correspond to functional units that are implemented by the CPU 121 executing programs to cause various hardware to perform functions. The functional units described above may be implemented by software, or part or all of the functional units may be implemented as hardware that provides equivalent functions.

All of the functional units described above may not necessarily be included in the configuration as illustrated in FIG. 5. For example, the functional units may be implemented by cooperation with another information processing apparatus.

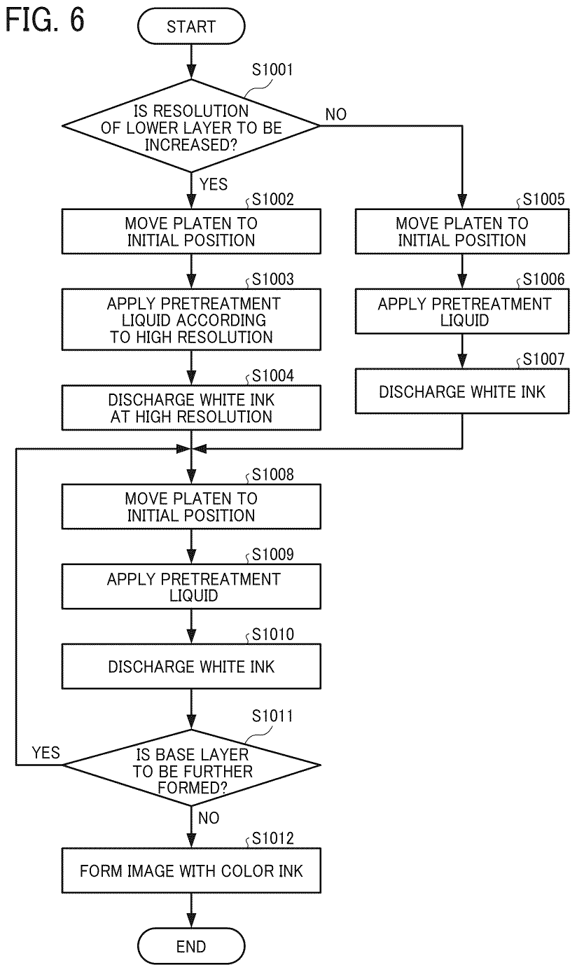

A process executed by the above-described functional units is described below with reference to FIG. 6. FIG. 6 is a flowchart of a process executed by the image forming apparatus 10. For example, when a print job is executed, the image forming apparatus 10 starts the process.

In step S1001, the process branches depending on whether the resolution of a lower layer of the base layer are to be increased. Whether to increase the resolution can be set by, for example, a user. If the resolution of the lower layer of the base layer is to be increased (YES in step S1001), the process proceeds to step S1002. In step S1002, the platen movement unit 544 moves the conveyance platen 101 to the initial position. The initial position of the conveyance platen 101 is a position serving as a reference for forming the base layer, that is, a position at which the base layer is started on the fabric. By moving the conveyance platen 101 to the initial position in step S1002, the base layer can be formed at an appropriate position of the fabric.

In step S1003, the pretreatment liquid application unit 541 applies the pretreatment liquid to the fabric in accordance with the resolution of white ink to be discharged in the subsequent processing. In step S1003, for example, the amount of the pretreatment liquid to be applied can be adjusted according to the resolution of the white ink. For example, in a case where the resolution of the white ink is increased, the pretreatment liquid application unit 541 can increase the amount of the pretreatment liquid. This makes it easier to fix the ink to the fibers of the fabric. In step S1004, the ink discharge unit 542 discharges the white ink at a high resolution. The resolution of the white ink in step S1004 can be set to any desired value, and can be set higher than the resolution in the subsequent processing (e.g., step S1010). Performing the processing of steps S1003 and S1004 while appropriately moving the carriage 100 and the conveyance platen 101 can form a high-resolution first layer (lower layer) of the base layer which is formed of the layer of the pretreatment liquid and the white ink.

On the other hand, in step S1001, when the resolution of the lower layer of the base layer is not to be increased (NO in step S1001), the process proceeds to step S1005. In step S1005, the platen movement unit 544 moves the conveyance platen 101 to the initial position. The processing of step S1005 is performed in the same manner as the processing of step S1002.

In step S1006, the pretreatment liquid application unit 541 applies the pretreatment liquid to the fabric. In step S1007, the ink discharge unit 542 discharges white ink. The resolution of the white ink in step S1007 can be set to any desired value, and can be set to be approximately the same as the resolution in the subsequent processing (e.g., step S1010). Performing the processing of steps S1006 and S1007 while appropriately moving the carriage 100 and the conveyance platen 101 can form the first layer (lower layer) of the base layer which is formed of the layer of the pretreatment liquid and the white ink.

After the first layer (lower layer) of the base layer is formed by the processing of steps S1002 to S1004 or the processing of steps S1005 to S1007, the process proceeds to step S1008 to form a second layer (upper layer) of the base layer. In step S1008, the platen movement unit 544 moves the conveyance platen 101 to the initial position. The processing of step S1008 is performed in the same manner as the processing of step S1005.

In step S1009, the pretreatment liquid application unit 541 applies the pretreatment liquid onto the fabric, that is, the first layer of the base layer. This can prevent the white ink discharged in the subsequent processing (e.g., step S1010) from easily passing through the fabric, and facilitate fixing of the base layer.

In step S1010, the ink discharge unit 542 discharges the white ink so as to be superimposed on the pretreatment liquid applied in step S1009. The processing of step S1010 can be performed in accordance with the movement of the carriage 100 and the conveyance platen 101, and thus, a layer of the white ink can be formed. The second layer (upper layer) of the base layer can be formed by the processing of steps S1009 and S1010.

In step S1011, the process branches depending on whether to further form a base layer. For example, in a case where the base layer is formed to have three or more layers (YES in step S1011), the process returns to step S1008 to further form a base layer, and the processing of steps S1008 to S1010 described above is repeated. On the other hand, when the base layer is not further formed (NO in step S1011), for example, when the base layer is formed of two layers or when a requested number of layers are formed in the case of forming the base layer of three or more layers, the process proceeds to step S1012.

In step S1012, the ink discharge unit 542 discharges non-white color ink to form a desired image according to the print job. In step S1013, the image forming apparatus 10 ends the process.

By performing the process of the flowchart illustrated in FIG. 6, the image forming apparatus 10 can form an image after appropriately forming the base layer. In particular, in the formation of the base layer including a plurality of white layers, the pretreatment liquid is applied before the white ink is discharged, and thus the white ink can be easily fixed to the fabric, and the performance of hiding the color of the fabric can be enhanced. Making the resolution of white ink of the lower layer higher than the resolution of white ink of the upper layer can prevent the white ink of the upper layer from easily passing through the lower layer and the fabric. Thus, the performance of hiding the color of the fabric can be further enhanced. Further, the hiding performance can be enhanced by forming the base layer with three or more layers.

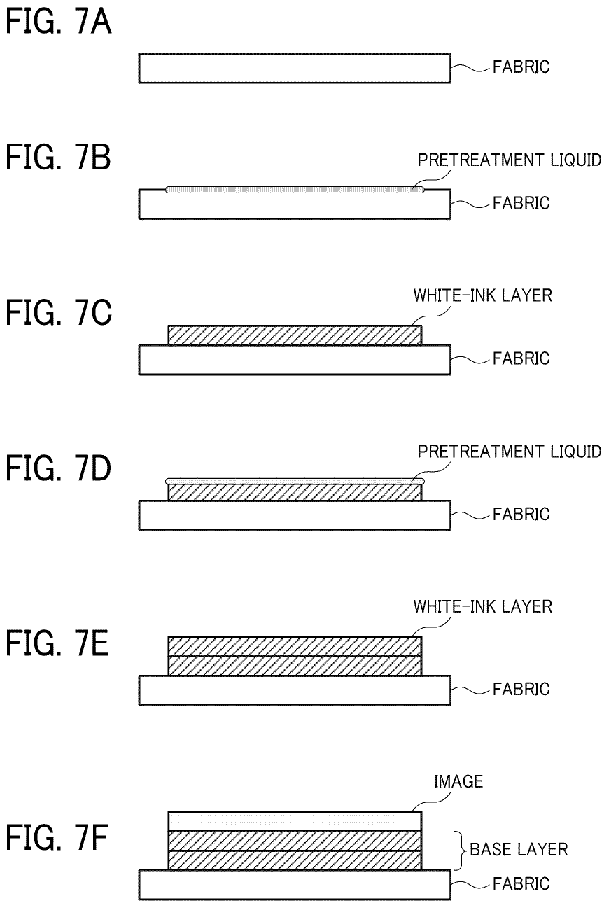

A description is given below of a configuration of a cross section of the base layer in the process illustrated in FIG. 6 with reference to FIGS. 7A to 7F. FIGS. 7A, 7B, 7C, 7D, 7E, and 7F are sectional views of a fabric and layers in the process of forming an image. FIG. 7A illustrates a sectional structure of the fabric before image formation.

FIG. 7B illustrates a sectional structure of the fabric to which pretreatment liquid is applied (see steps S1003 and S1006 in FIG. 6). When the pretreatment liquid is applied, a layer of the pretreatment liquid is formed on the surface of the fabric as illustrated in FIG. 7B.

FIG. 7C illustrates a sectional structure of the fabric on which white ink is discharged over the layer of the pretreatment liquid (see steps S1004 and S1007 in FIG. 6). When the white ink is discharged, a layer of the white ink is formed on the surface of the fabric as illustrated in FIG. 7C. The white ink is less likely to pass through the fabric due to the pretreatment liquid, and thus can be fixed to the fabric to form a layer.

FIG. 7D illustrates a sectional structure of the fabric on which the pretreatment liquid is discharged over the layer of the white ink (see step S1009 in FIG. 6). When the pretreatment liquid is applied, a layer of the pretreatment liquid is formed on the white ink layer as illustrated in FIG. 7D.

FIG. 7E illustrates a sectional structure of the fabric on which the white ink is discharged over the layer of the pretreatment liquid (see step S1010 in FIG. 6). When the white ink is discharged, a second (upper) layer of the white ink is formed as illustrated in FIG. 7E. In such a manner, the base layer is formed by a plurality of layers of white ink, and thus the performance of hiding the color of the fabric can be enhanced.

FIG. 7F illustrates a sectional structure of the fabric on which color ink is discharged and the image is formed on the base layer (see step S1012 in FIG. 6). By discharging the color ink, a desired image according to the print job is formed. As described above, by forming an image on the base layer including a plurality of layers of white ink, the image can be formed while the color of the fabric is appropriately concealed. Thus, the visibility of the image can be enhanced.

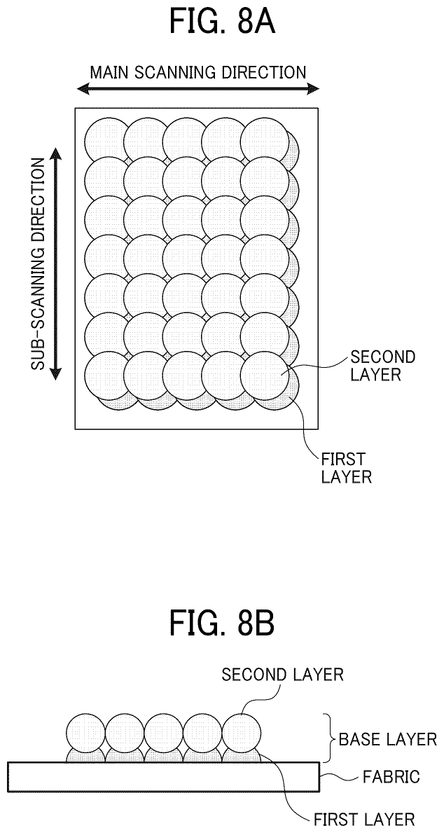

A description is given below of examples of the configuration of the base layer with reference to FIGS. 8 to 12.

FIGS. 8A and 8B are diagrams illustrating a first example of the configuration of a base layer. FIGS. 8A and 8B illustrate an example in which white ink is discharged at the same resolution onto a first layer and a second layer of a base layer. By forming the base layer having the structure illustrated in FIGS. 8A and 8B, the performance of hiding the color of the fabric can be enhanced.

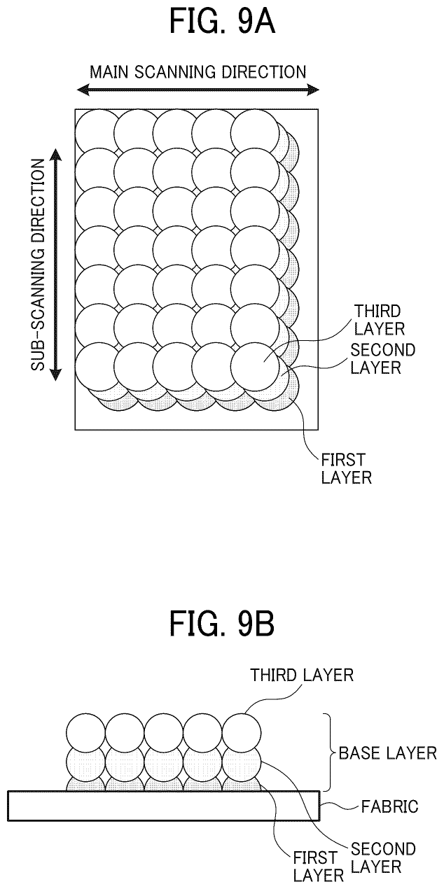

FIGS. 9A and 9B are diagrams illustrating a second example of the configuration of a base layer. FIGS. 9A and 9B illustrate an example in which the base layer is formed of three layers of white ink. By forming the base layer having the structure illustrated in FIGS. 9A and 9B, for example, the performance of hiding the color of the fabric can be further enhanced as compared with the structure illustrated in FIGS. 8A and 8B.

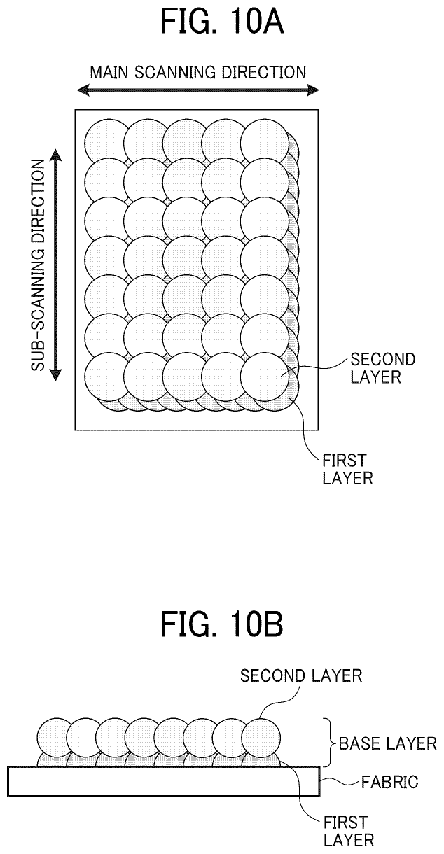

FIGS. 10A and 10B are diagrams illustrating a third example of the configuration of a base layer. FIGS. 10A and 10B illustrate an example in which the base layer is formed by increasing the resolution of white ink of a lower layer, and more specifically, the base layer is formed by increasing the density of the white ink of the lower layer to be discharged in the main scanning direction and the sub-scanning direction. By forming the base layer having the structure illustrated in FIGS. 10A and 10B, the white ink of a second (upper) layer is less likely to pass through the lower layer and the fabric since the density of the ink of the lower layer is high. Thus, the performance of hiding the color of the fabric can be further enhanced as compared with the structure illustrated in, for example, FIGS. 8A and 8B.

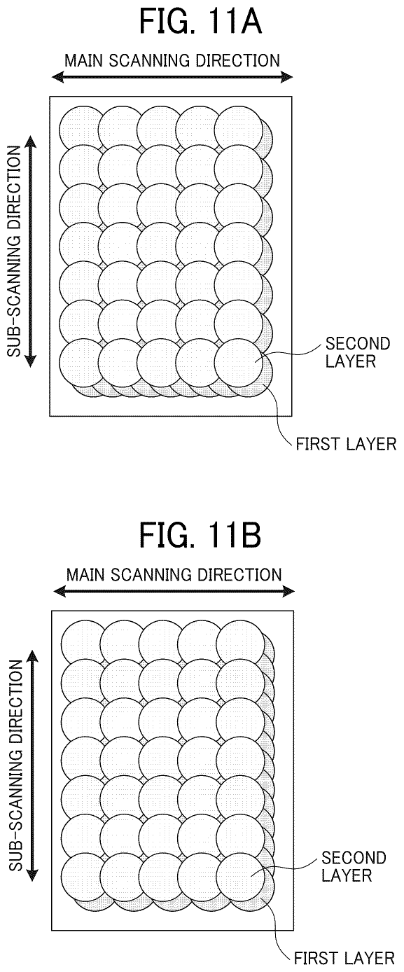

FIGS. 11A and 11B are diagrams illustrating a fourth example and a fifth example of the configuration of a base layer. Although the density of white ink in the main scanning direction and the sub-scanning direction of the lower layer is increased in FIGS. 10A and 10B, from the viewpoint of saving the amount of ink used, as illustrated in FIGS. 11A and 11B, a configuration in which the density of white ink discharged in either the main scanning direction or the sub-scanning direction is increased may be adopted. FIG. 11A illustrates an example in which the base layer is formed by increasing the density of white ink discharged in the main scanning direction. FIG. 11B illustrates an example in which the base layer is formed by increasing the density of white ink discharged in the sub-scanning direction. Forming the base layer having the structure illustrated in FIG. 11A or 11B can increase the density of white ink while saving the white ink, reduce the cost, and enhance the performance of hiding the color of the fabric.

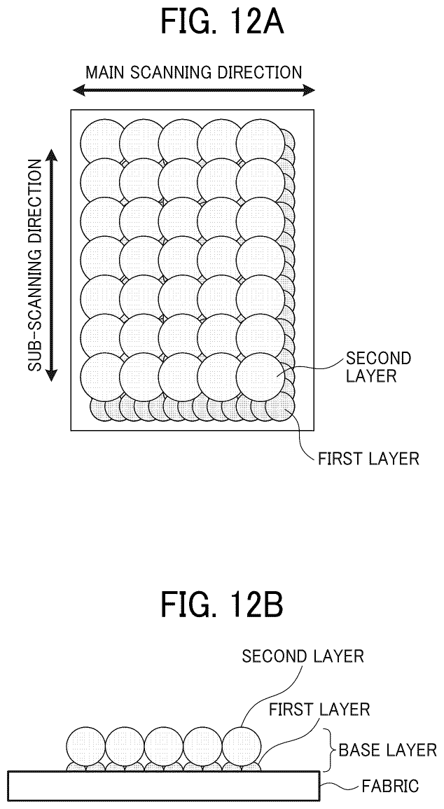

FIGS. 12A and 12B are diagrams illustrating a sixth example of the configuration of a base layer. FIGS. 12A and 12B illustrate an example in which the base layer is formed by increasing the resolution of white ink of a lower layer, and more specifically, the base layer is formed by increasing the resolution and reducing the size of droplets of the white ink of the lower layer. By forming the base layer having the structure illustrated in FIGS. 10A and 10B, the density of the ink of the lower layer can be increased while reducing the amount of white ink used. Thus, the white ink of the second layer is less likely to pass through the lower layer and the fabric, and the performance of hiding the color of the fabric can be further enhanced as compared with the structure illustrated in, for example, FIGS. 8A and 8B.

According to the above-described embodiments of the present disclosure, an image forming apparatus and an image forming method for appropriately forming a base layer on a fabric can be provided.

Each of the functions of the above-described embodiments of the present disclosure can be implemented by a device-executable program written in, for example, C, C++, C#, and JAVA®. The program according to an embodiment of the present disclosure can be stored in a device-readable recording medium to be distributed. Examples of the recording medium include a hard disk drive, a compact disc-read-only memory (CD-ROM), a magnetooptic (MO) disk, a digital versatile disk (DVD), a flexible disk, an electrically erasable programmable read-only memory (EEPROM®), and an erasable programmable read-only memory (EPROM). The program can be transmitted over a network in a form with which another computer can execute the program.

Each function of the embodiments described above can be implemented by one processing circuit or a plurality of processing circuits. The term “processing circuit or circuitry” in the present specification includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit components arranged to perform the recited functions.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Although several embodiments of the present disclosure have been described above, embodiments of the present disclosure are not limited to the above-described embodiments, and various modifications may be made without departing from the spirit and scope of the present disclosure that can be estimated by skilled person. Such modifications exhibiting functions and effects of the present disclosure are included within the scope of the present disclosure.

1. An image forming apparatus, comprising:
an applicator to apply a pretreatment liquid to a fabric;
a discharger to discharge an ink onto the fabric; and
processing circuitry configured to cause the applicator to apply the pretreatment liquid and cause the discharger to discharge a white ink to form at least two base layers including the pretreatment liquid and the white ink.

2. The image forming apparatus according to claim 1,
wherein the processing circuitry is configured to cause the discharger to discharge the white ink so that a resolution of the white ink in a lower layer is higher than a resolution of the white ink in an upper layer in the at least two base layers.

3. The image forming apparatus according to claim 2,
wherein the processing circuitry is configured to cause the discharger to discharge the white ink so that a density of the white ink discharged to form the lower layer is higher than a density of the white ink discharged to form the upper layer.

4. The image forming apparatus according to claim 3,
wherein the processing circuitry is configured to cause the discharger to discharge the white ink so that a density of the white ink discharged in a main scanning direction of the lower layer is higher than a density of the white ink discharged in the main scanning direction of the upper layer.

5. The image forming apparatus according to claim 3,
wherein the processing circuitry is configured to cause the discharger to discharge the white ink so that a density of the white ink discharged in a sub-scanning direction of the lower layer is higher than a density of the white ink discharged in the sub-scanning direction of the upper layer.

6. The image forming apparatus according to claim 2,
wherein the processing circuitry is configured to cause the discharger to discharge the white ink so that a droplet size of the white ink discharged in the lower layer is smaller than a droplet size of the white ink discharged in the upper layer.

7. The image forming apparatus according to claim 1,
wherein the processing circuitry is configured to cause the discharger to discharge non-white ink onto the at least two base layers to form an image on the fabric.

8. The image forming apparatus according to claim 1, further comprising a carriage from which the applicator discharges the pretreatment liquid.

9. The image forming apparatus according to claim 1, wherein the applicator includes a structure to spray the pretreatment liquid.

10. A method of forming an image on a fabric, the method comprising:
applying a pretreatment liquid to the fabric;
discharging a white ink to the fabric, after the applying of the pretreatment liquid, to form a white ink layer; and
discharging a non-white ink, after repeating the applying of the pretreatment liquid and the forming of the white ink two or more times, to form the image on the fabric.
